(19) United States
(12) Patent Application Publication
(10) Pub. No.: US 2007/0034294 A1
(43) Pub. Date: Feb. 15, 2007

(54) Load control for stump cutter

(75) Inventor: Bruce G. Chapman, Wooster, OH (US)

Correspondence Address: SAND & SEBOLT, AEGIS TOWER, SUITE 1100, 4940 MUNSON STREET, NW, CANTON, OH, 44718-3615, US

(73) Assignee: RAYCO MANUFACTURING, INC., Wooster, OH (US)

(21) Appl. No.: 11/179,738

(22) Filed: Jul. 11, 2005

(51) Int. Cl. A01G 23/06; B27B 1/00; B23Q 15/00; B27M 3/00; B23Q 16/00

(52) U.S. Cl. 144/334; 144/356; 144/394; 144/402; 144/24.12

(57) ABSTRACT

A load control system controls movement of a cutter wheel of a stump cutter wherein the cutter wheel rotates at a rotational speed independent of the rotational speed of an engine which powers the stump cutter. The stump cutter includes a hydrostatic transmission having a variable displacement hydraulic pump whereby the rotational speed of the cutter wheel is independent of that of the engine. The load control system includes a sensor for directly or indirectly sensing the rotational speed of the cutter wheel, a microprocessor for determining a response to changes in cutter wheel rotational speed and trim valves for controlling the feed rate of the cutter wheel.

### BACKGROUND OF THE INVENTION

1. Technical Field

The invention relates generally to machines having rotating cutters. More particularly, the invention relates to a stump cutter having a maneuverable cutter wheel with cutting teeth mounted thereon. Specifically, the invention relates to a stump cutter having a hydraulically driven cutter wheel and a load control or feed rate control mechanism.

2. Background Information

Stump cutters generally have cutting teeth on the side of a rotating disc known as the cutter wheel. Thus, the side of the wheel is fed laterally into the stump, usually by pivoting the boom on which the cutter wheel is rotatably mounted. Actuators which are typically hydraulically driven control the feed rate of this lateral movement. In addition, the cutter wheel may be moved up and down and fore and aft. The present invention is concerned with all these movements, but most particularly with the lateral or side-to-side movement of the cutter wheel, which is the feed direction thereof.

One of the problems that arises during the operation of a stump cutter relates to the load experienced by the cutter wheel. If the increased load exceeds a certain value, it may cause damage to the stump cutter. While this damage may occur to various elements of the stump cutter, one of the greatest concerns is overloading the engine which drives the stump cutter. Traditionally, stump cutters are driven by an engine wherein there is a direct relation between the engine speed and the cutter wheel speed during operation of the stump cutter. Various drive trains are used between the engine and the cutter wheel, such as V-belt systems, synchronous belts, gear boxes and various combinations thereof. To prevent the cutter wheel from advancing faster than the machine can bear, load controls have been put on stump cutters to automatically control the speed of advancement, thus maintaining a stump cutter's cutting action and engine speed in a more optimal range, thereby enhancing performance and reducing the overload of the machine, the fatiguing of components and stalling of the engine. Such control systems are disclosed in U.S. Pat. No. 5,588,474 granted to Egging and U.S. Pat. Nos. 5,845,689 and 6,014,996 granted to Egging et al.

One of the major problems that arises from such stump cutters and related load control systems relates to the engine speed being directly related to the cutter wheel speed. Due to this fact, the present load control systems must effectively sense the engine speed in order to appropriately control the feed rate of the cutter wheel. This means that the load experienced by the cutter wheel will necessarily be experienced by the engine as well. Thus, there is no way to completely avoid additional load to the engine when the cutter wheel experiences an increased load.

Some of the newer stump cutters are hydrostatically powered so that there is not a direct relation between the engine speed and the cutter wheel speed. Typically, such stump cutters are hydrostatically powered so that the engine drives a hydrostatic transmission whereby the cutter wheel is driven by a hydraulic motor. Because these stump cutters do not have a direct relation between the engine speed and the cutter wheel speed, the present load control systems used on traditional stump cutters are not effective on these newer stump cutters. Thus, there is a need for a load control system for stump cutters using hydrostatic transmissions and the like.

### BRIEF SUMMARY OF THE INVENTION

The present invention provides a method comprising the steps of sensing a load upon a rotating cutter wheel of a stump cutter independently of a rotational speed of an engine which powers the stump cutter; and controlling the cutter wheel based on the load on the cutter wheel.

The present invention also provides a method comprising the steps of sensing a load upon a rotating cutter wheel of a stump cutter wherein the cutter wheel is powered by an engine via a hydrostatic transmission; and controlling the cutter wheel based on the load on the cutter wheel.

The present invention further provides a stump cutter comprising an engine which is operable at an engine rotational speed; a rotatable cutter wheel having a feed rate; a sensor for sensing a load on the cutter wheel independently of the engine rotational speed; and a feed rate control mechanism for controlling the feed rate of the cutter wheel.

### BRIEF DESCRIPTION OF THE SEVERAL VIEWS OF THE DRAWINGS

FIG. 1 is a side elevational view of the stump cutter of the present invention.

FIG. 2 is a diagrammatic view of the power and load control system of the present invention with the transmission in a neutral position.

FIG. 3 is similar to FIG. 2 except that controls have been operated to put the transmission in a forward position in order to drive the cutter wheel in a forward direction for cutting.

FIG. 4 is similar to FIG. 3 except that controls have been operated to put the transmission in a reverse position in order to drive the cutter wheel in a reverse direction.

FIG. 5 is similar to FIG. 3 with the transmission in the forward position and the cutter wheel advancing to cut the stump.

FIG. 6 is similar to FIG. 5 and shows the cutter wheel further advanced at a further stage of cutting the stump.

FIG. 7 is similar to FIG. 6 with the cutter wheel further advanced and the stump being nearly completely cut.

FIG. 8 is a graphical view showing the relation between a trim valve status and the feed rate of the cutter wheel.

FIG. 9 is a flow chart concerning automated control of the cutter wheel feed rate.

Similar numbers refer to similar parts throughout the specification.

### DETAILED DESCRIPTION OF THE INVENTION

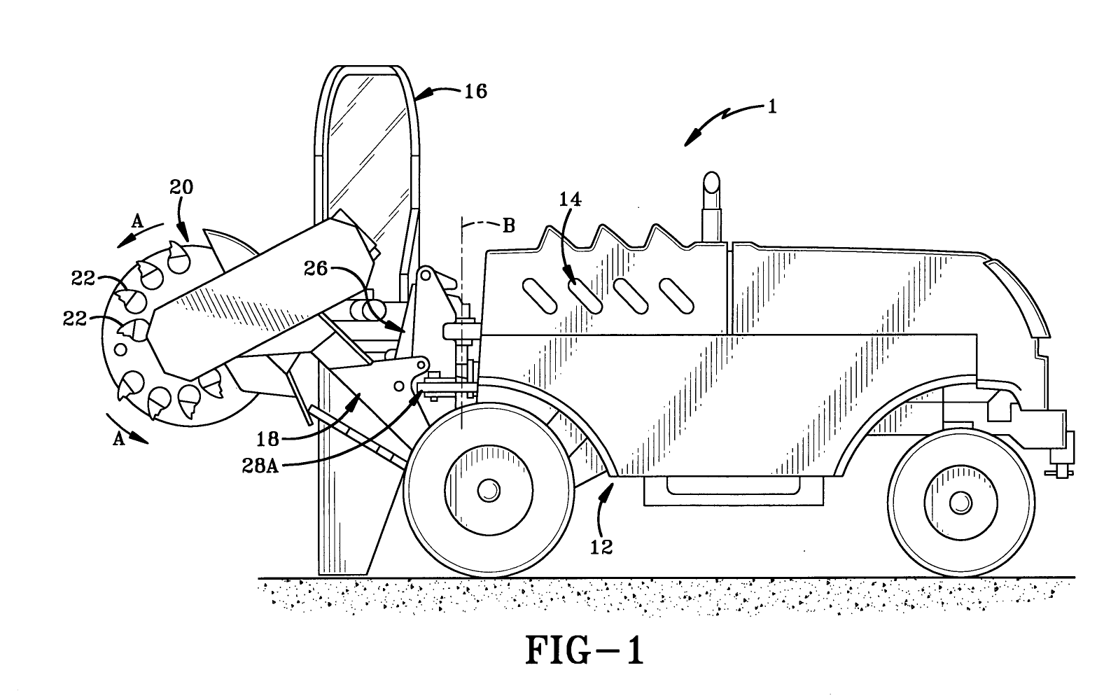

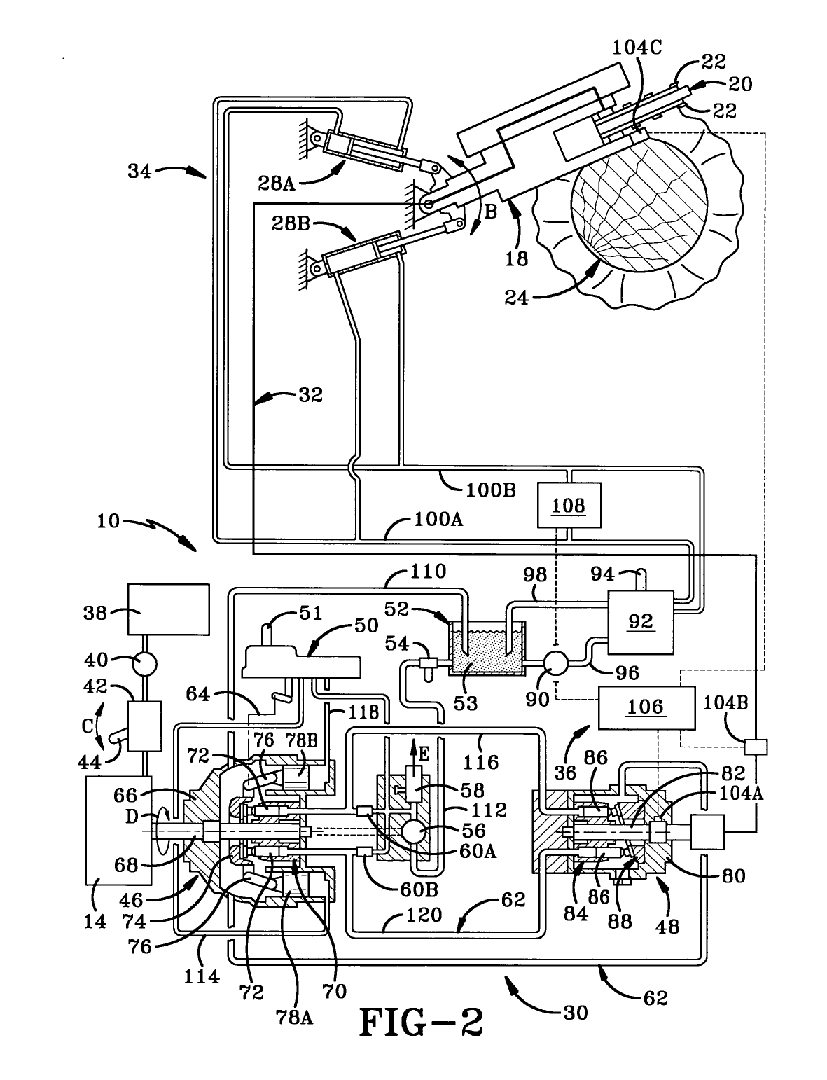

The stump cutter of the present invention is indicated generally at 1 in FIG. 1 and the power and load control system of the present invention is indicated generally at 10 in FIG. 2. Referring to FIG. 1, stump cutter 1 is a wheeled vehicle having a frame 12 with an engine 14 mounted thereon. A control panel 16 is pivotally mounted on frame 12 for controlling various movements of stump cutter 1. A boom 18 is movably mounted on frame 12 and supports a cutter wheel 20 rotatably thereon as indicated by Arrows A. A plurality of cutting teeth 22 are mounted on each side of cutter wheel 20 for cutting a stump 24 (FIG. 2) upon rotation of cutter wheel 20.

With continued reference to FIG. 1, boom 18 and cutter wheel 20 are more particularly movable in an upward and downward direction by operation of an actuator 26 which is typically a hydraulically driven piston-cylinder combination. In addition, boom 18 and cutter wheel 20 are movable laterally or in a side-to-side fashion. This is most commonly accomplished by pivotal rotation about a substantially vertical axis B by operation of a pair of swing actuators 28A and 28B (FIG. 2), each of which is pivotally mounted on frame 12 and on respective opposed sides of boom 18.

With reference to FIG. 2, system 10 includes engine 14, a hydrostatic transmission 30, a drive train 32, a swing control or advance control assembly 34 and a load control assembly 36. In general, engine 14 operates to produce a rotational output to drive transmission 30, which produces a rotational output to rotatably drive cutter wheel 20 via drive train 32. Advance control assembly 34 controls the lateral movement of cutter wheel 20, commonly known as the swing or advance of cutter wheel 20 as indicated by Arrow B. This advance may be controlled manually, and in accordance with the invention, load control assembly 36 may also automatically control the advance so that cutter wheel 20 operates at an optimum rate and prevents the additional loading or overloading of engine 14.

With continued reference to FIG. 2, engine 14 is typically a fuel powered engine and thus when operated draws fuel from a source of fuel 38 via a fuel pump 40. An engine control 42 is provided to turn engine 14 on and off and includes a switch 44 which is moveable as indicated at Arrow C in order to control the rate of speed at which engine 14 operates.

With continued reference to FIG. 2, transmission 30 includes a variable displacement hydraulic pump 46, a hydraulic motor 48, a pump control mechanism in the form of a pump control valve 50 having a lever 51, a reservoir 52 for containing hydraulic fluid 53, a filter 54, a charge pump 56, a charge pump relief valve 58, a pair of check valves 60A and 60B and a plurality of hydraulic lines indicated generally at 62 which interconnect these elements of transmission 30 as will be further detailed below. Transmission 30 further includes a connecting link 64.

Pump 46 includes a housing 66 and an input shaft 68 which is rotatably mounted on housing 66 and rotationally driven by engine 14. A barrel 70 is rigidly mounted on input shaft 68 within housing 66 with a plurality of pumping pistons 72 movably mounted within cylinders defined by barrel 70. Pump 46 further includes a variable or variable-tilt swash plate 74 which is pivotally mounted within housing 66 with a pair of connecting arms 76 pivotally mounted thereon. A pair of servo pistons 78A and 78B are respectively pivotally mounted on connecting arms 76 within housing 66.

Hydraulic motor 48 includes a housing 80 and an output shaft 82 rotatably mounted thereon. A barrel 84 is fixedly mounted on output shaft 82 within housing 80 with a plurality of driving pistons 86 movably mounted within cylinders defined by barrel 84. Motor 48 further includes a fixed swash plate 88 which is disposed within housing 80 and has a fixed tilt angle.

Drive train 32 is rotationally connected to output shaft 82 of transmission 30. Drive train 32 includes an input shaft for rotationally driving cutter wheel 20. Drive train 32 may include various belt systems, drive shafts and gear boxes or any other suitable components for translating rotational movement from output shaft 82 to cutter wheel 20.

Advance control assembly 34 includes a hydraulic pump 90 and a pump control valve 92 which includes a control switch 94. Control valve 92 is in fluid communication with pump 90 and reservoir 52 via a feed line 96 and in fluid communication with reservoir 52 via a return line 98. Feed/return lines 100A and 100B provide fluid communication between pump control valve 92 and swing actuators 28A and 28B. More particularly, line 100A branches into two lines one of which is in fluid communication with a butt end of actuator 28A and the other of which is in fluid communication with a rod end of actuator 28B. Likewise, line 100B branches with one line going to a rod end of actuator 28A and the other line going to a butt end of actuator 28B.

Load control assembly 36 includes a sensor 104 for sensing the rotational speed of cutter wheel 20, a load control module in the form of a microprocessor 106 and a hydraulic flow control mechanism in the form of a trim valve 108. Sensor 104 is shown in alternate positions. In particular, sensor 104A is mounted on hydraulic motor 48 in order to measure the rotational speed of output shaft 82, which is directly related to the rotational speed of cutter wheel 20. Alternately, sensor 104B may be positioned adjacent drive train 32 in order to sense, for example, the rotational speed of a drive shaft or gear or the revolutions of a belt component that drives cutter wheel 20 or is driven by cutter wheel 20. Alternately, sensor 104C may be mounted adjacent cutter wheel 20 to directly measure the rotational speed of cutter wheel 20 or of other components having a direct relationship to the rotational speed of cutter wheel 20. Sensor 104 is in communication with microprocessor 106, as indicated by the dashed lines extending respectively therebetween. This may be an electrical communication via wires or may be a wireless transmission, such as radio frequency or other commonly known means of wireless transmission.

Control valve 92 is in fluid communication with trim valve 108 which is in communication (electrical or otherwise) with microprocessor 106 as indicated by the dashed line extending therebetween. Trim valve 108 is in fluid communication with each of feed/return lines 100A and 100B. Trim valve 108 may be in the form of a relief valve which simply allows hydraulic fluid to be dumped between feed/return lines 100A and 100B or may be in the form of a variable-flow valve whereby the flow between the feed/return lines may be controlled at variable rates. Alternately, for example, the hydraulic fluid flow control mechanism may be in the form of a load-sensing pump which controls all of the actuators on the stump cutter as desired.

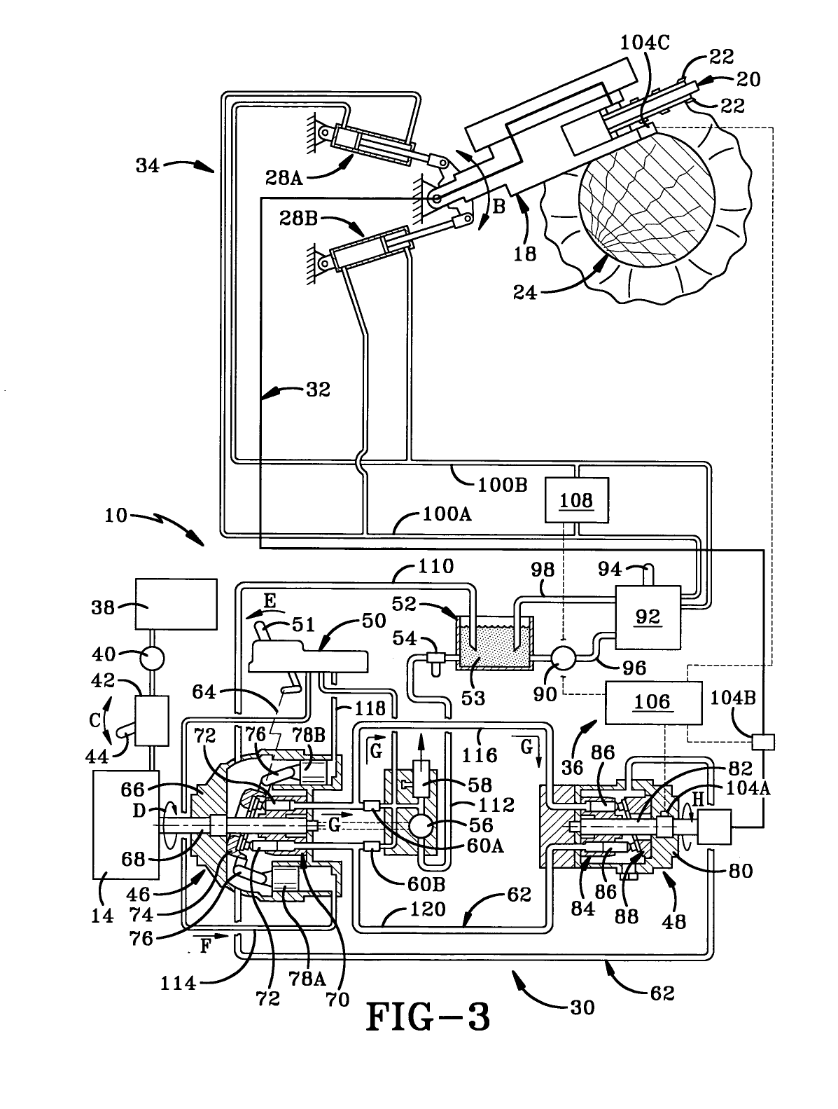

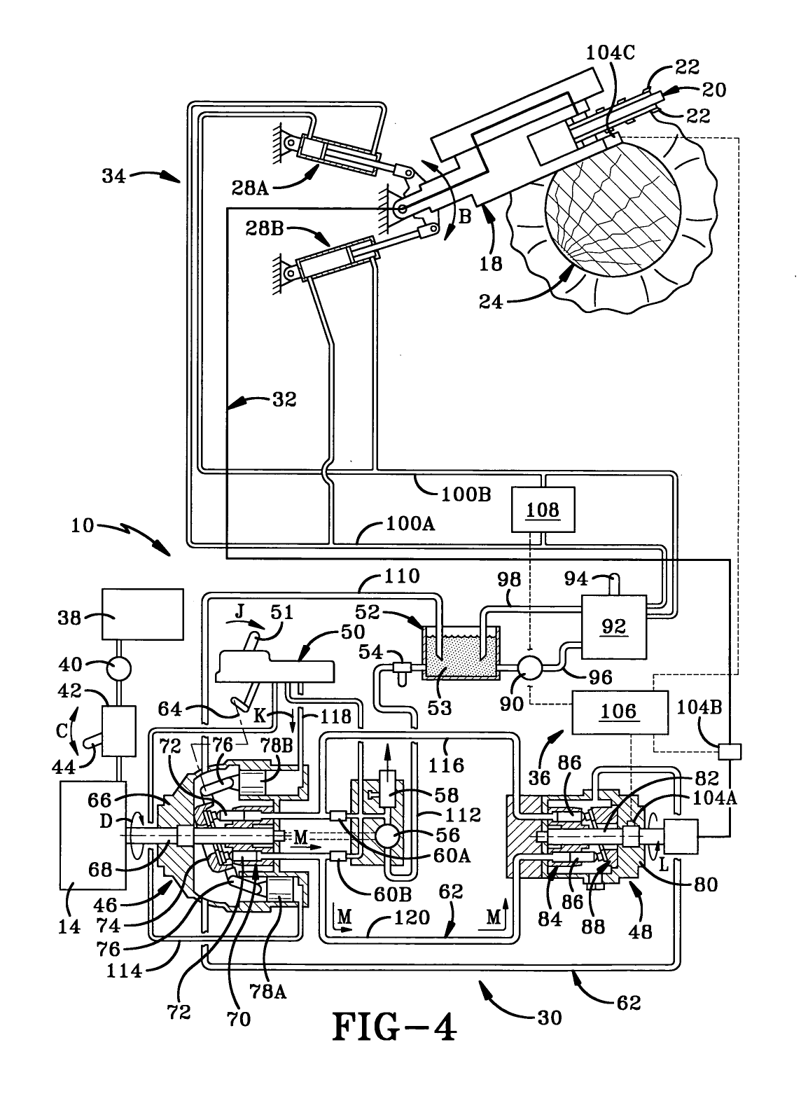

The operation of power and load control system 10 will now be described with reference to FIGS. 2-7, with the initial discussion primarily focusing on the operation of transmission 30. Transmission 30 controls the direction of rotation and the rotational speed of cutter wheel 20. When transmission 30 is in neutral (FIG. 2), cutter wheel 20 is stopped. To drive cutter wheel 20 in the forward or cutting direction indicated by Arrows A in FIG. 1, transmission 30 must be in a forward position (FIG. 3) and to drive cutter wheel 20 in the reverse direction, transmission 30 must be in a reverse position (FIG. 4). Typically, cutter wheel 20 is not rotated in the reverse direction, but the description is included herein as an option.

With reference to FIG. 2, the operation of system 10 begins with the operation of engine 14, the operating speed of which is controlled by switch 44 which is shown in a position corresponding to a maximum or relatively high operating speed. While this rate of speed of engine 14 obviously may vary as desired, engine 14 is typically run at relatively high operational speeds. Operation of engine 14 produces a rotational output as indicated by Arrow D to rotationally drive input shaft 68 of pump 46 in the direction indicated by Arrow D. Engine 14 will produce rotational output in this direction regardless of the operation of transmission 30. As will be further detailed, the key to transmission 30 being in the neutral position shown in FIG. 2 is the fact that variable swash plate 74 remains in a neutral position which is perpendicular to the axis about which input shaft 68 rotates. When transmission 30 is in the neutral position, charge pump 56, in combination with check valves 60A and 60B introduces hydraulic fluid to both sides of the hydrostatic circuit and fills all lines 62 between pump 46 and motor 48 so that hydraulic fluid is available for use when transmission 30 is moved from the neutral position to either the forward or reverse positions indicated respectively in FIGS. 3 and 4. When the circuit is thus primed, the charge pump flow dumps across charge pump relief valve 58 as indicated by Arrow E into housing 66 of pump 46 and subsequently returns to reservoir 52 via a return line 110, although these connections are not shown. Charge pump 56 draws hydraulic fluid 53 from reservoir 52 through filter 54 via a feed line 112. Charge pump 56 is driven by input shaft 68 as indicated by the dashed lines extending therebetween.

Thus, when lever 51 of control valve 50 is in a neutral position and thus transmission 30 is in the neutral position of FIG. 2, engine 14 rotationally drives input shaft 68 and in turn barrel 70 along with the pumping pistons 72 disposed therein. However, because variable swash plate 74 is in the neutral position, pistons 72 do not reciprocate to pump the hydraulic fluid. Rather, pistons 72 slidingly engage swash plate 74, but do not pump due to the neutral position of swash plate 74. Swash plate 74 is held in this neutral position by centering springs (not shown) located adjacent servo pistons 78A and B. Because no hydraulic fluid is flowing through transmission 30, hydraulic motor 48 does not produce any rotational output and therefore cutter wheel 20 is in a stopped position. Lever 51 of control valve 50 is in a neutral position when transmission 30 is in a neutral position.

In order to rotate cutter wheel 20 in a forward or cutting direction, transmission 30 must be in the forward position (FIG. 3). To achieve this, lever 51 of control valve 50 is moved as indicated by Arrow E in FIG. 3 to a forward operating position. Engine control switch 44, however, remains in the same position so that engine 14 is rotating at the previously selected operational speed. Movement of lever 51 to the operational position moves a spool (not shown) within pump control valve 50 in order to allow hydraulic fluid through a line 114 as indicated by Arrow F into the cylinder associated with servo piston 78A. The hydraulic fluid thus pushes servo piston 78A to tilt variable swash plate 74 to a tilt angle which will allow pump 46 to begin pumping hydraulic fluid to hydraulic motor 48. Once lever 51 is set to the desired position to produce a desired rotational output of hydraulic motor 48, connecting link 64 operates to move the servo within control valve 50 back in place in order to maintain variable swash plate 74 at the tilt angle associated with this desired rotational output. Once swash plate 74 has been tilted as described, the rotation of input shaft 68 and barrel 70 permits pumping pistons 72 to reciprocate as they ride along the tilted surface of swash plate 74, thereby pumping hydraulic fluid as indicated at Arrows G through a hydraulic line 116 and into hydraulic motor 48. At this time, check valve 60A is closed to prevent backflow of hydraulic fluid toward charge pump 56. The pressure of hydraulic fluid via line 116 on driving pistons 86 of hydraulic motor 48 causes pistons 86 to extend and thereby slide along the angled fixed swash plate 88. As seen in FIG. 3, the upper driving piston shown is in a retracted position while the lower piston 86 has been extended due to this pressure. This extension of pistons 86 thus causes the rotation of barrel 84 and output shaft 82 along with barrel 84, as indicated at Arrow H. Thus, the rotational output of output shaft 82 of hydraulic motor 48 rotationally engages drive train 32 in order to rotatably drive cutter wheel 20 for cutting stump 24.

Thus, transmission 30 and in particular the positioning of variable swash plate 74 is the controlling factor in what determines the rotational output of hydraulic motor 48 and thus the rotational speed of cutter wheel 20. While engine 14 may be set at different operational speeds during this process, engine 14 typically runs at a constant relatively high rate of speed as previously noted. Thus, the rotational output of motor 48 and the rotational speed of cutter wheel 20 is very independent from the rotational speed of engine 14.

As previously noted, transmission 30 may also be operated in reverse when in the reverse position of FIG. 4. While engine 14 remains at the previously chosen rotational speed, lever 51 may be moved as indicated at Arrow J to a reverse position in order to allow the servo within control valve 50 to move in the opposite direction and thus allow hydraulic fluid to flow as indicated by Arrow K through a hydraulic line 118 into the cylinder associated with servo piston 78B within hydraulic pump 46. Thus, the hydraulic fluid applies pressure to servo piston 78B in order to pivot variable swash plate 74 at a tilt angle for reverse operation of transmission 30 and subsequently the reverse operation of hydraulic motor 48 and cutter wheel 20. Thus, the reverse position of variable swash plate 74 ultimately causes output shaft 82 of hydraulic motor 48 to rotate in the reverse direction as indicated at Arrow L. The overall operational concept of hydraulic pump 46 remains the same except that the reversal of the swash plate 74 tilt angle causes the hydraulic fluid to pump in the opposite direction as indicated by Arrows M via a hydraulic line 120. The pressurized fluid flowing through line 120 causes check valve 60B to close during this operation. Thus, while engine 14 continues to rotate in the direction indicated by Arrow D at the same rotational speed, the rotational output of hydraulic pump 48 has not only been varied but reversed, underscoring the independence of the rotational output of pump 48 with regard to the engine speed of engine 14.

The hydrostatic transmission 30 discussed herein is particularly shown as a closed loop hydrostatic transmission. Suitable hydrostatic transmissions for this purpose are available from Eaton Corporation of Cleveland, Ohio. It is noted that an open loop hydraulic circuit may also be used in this manner, although the closed loop circuits typically provide the greater power desired for use with a stump cutter.

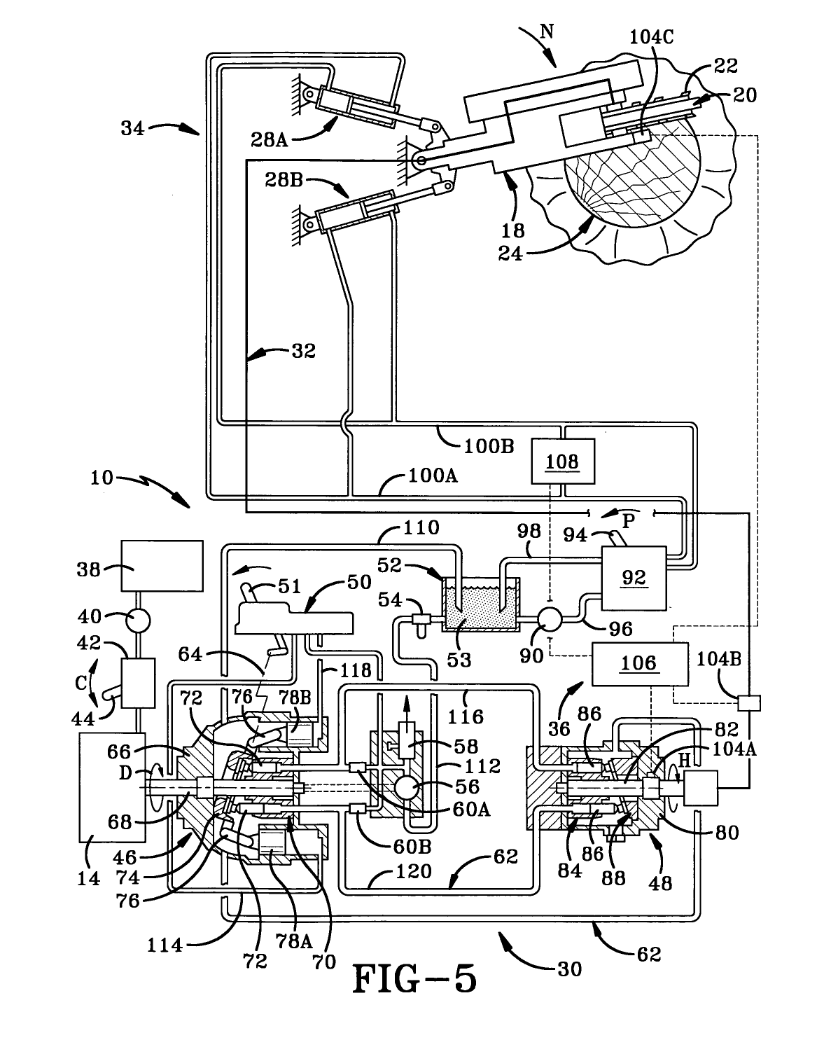

With reference to FIG. 5, system 10 is being operated with transmission 30 in the forward position in order to cut stump 24 as cutter wheel 20 is advanced laterally as indicated at Arrow N toward stump 24. To that effect, switch 94 has been adjusted as indicated at Arrow P in order to control the hydraulic pressure within hydraulic lines 100A and B to provide the desired advance rate or feed rate of cutter wheel 20 in the direction indicated by Arrow N. More particularly, in order to cause the cutter wheel to move in the direction of Arrow N, the hydraulic pressure within line 100B is greater than that within 100A in order to cause the piston of actuator 28A to extend and the piston of actuator 28B to retract. Thus, the operator of stump cutter 1 manually controls switch 94 in order to create these pressure differentials to set and control a feed rate or advance rate of cutter wheel 20. However, it is difficult for an operator to manually control this advance rate of cutter wheel 20 at an optimum rate and it is also easy to allow cutter wheel 20 to experience an overload condition which can affect the rest of assembly 10, especially when the operator of stump cutter 1 may become distracted, etc.

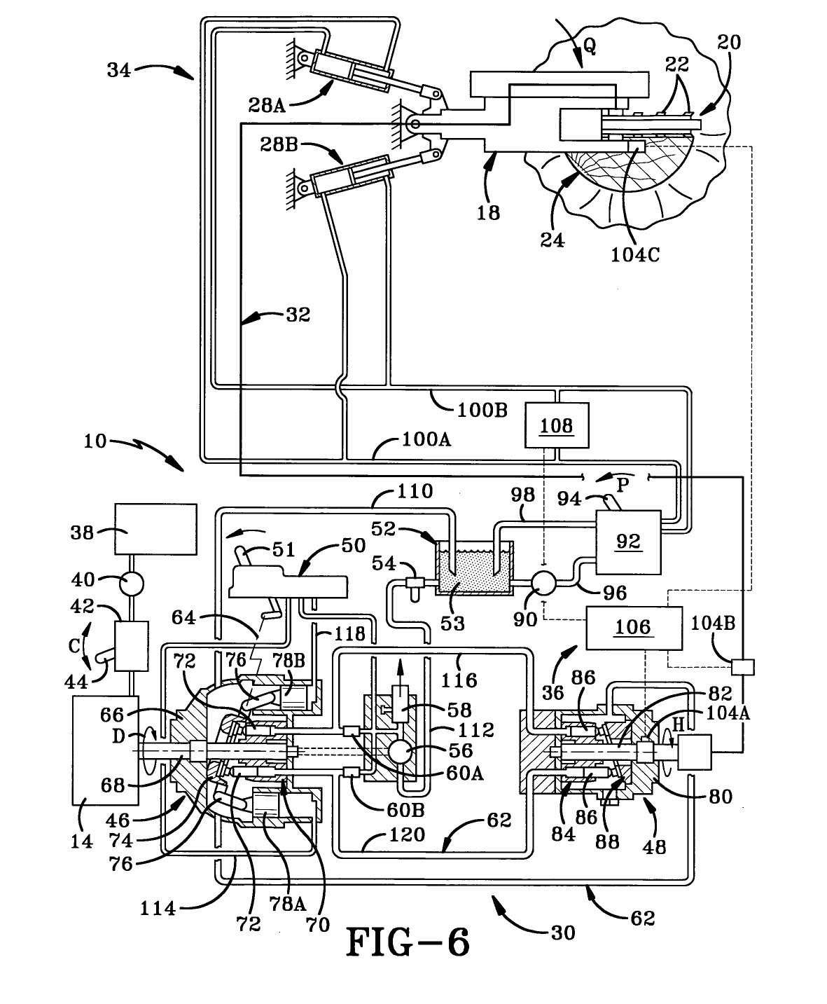

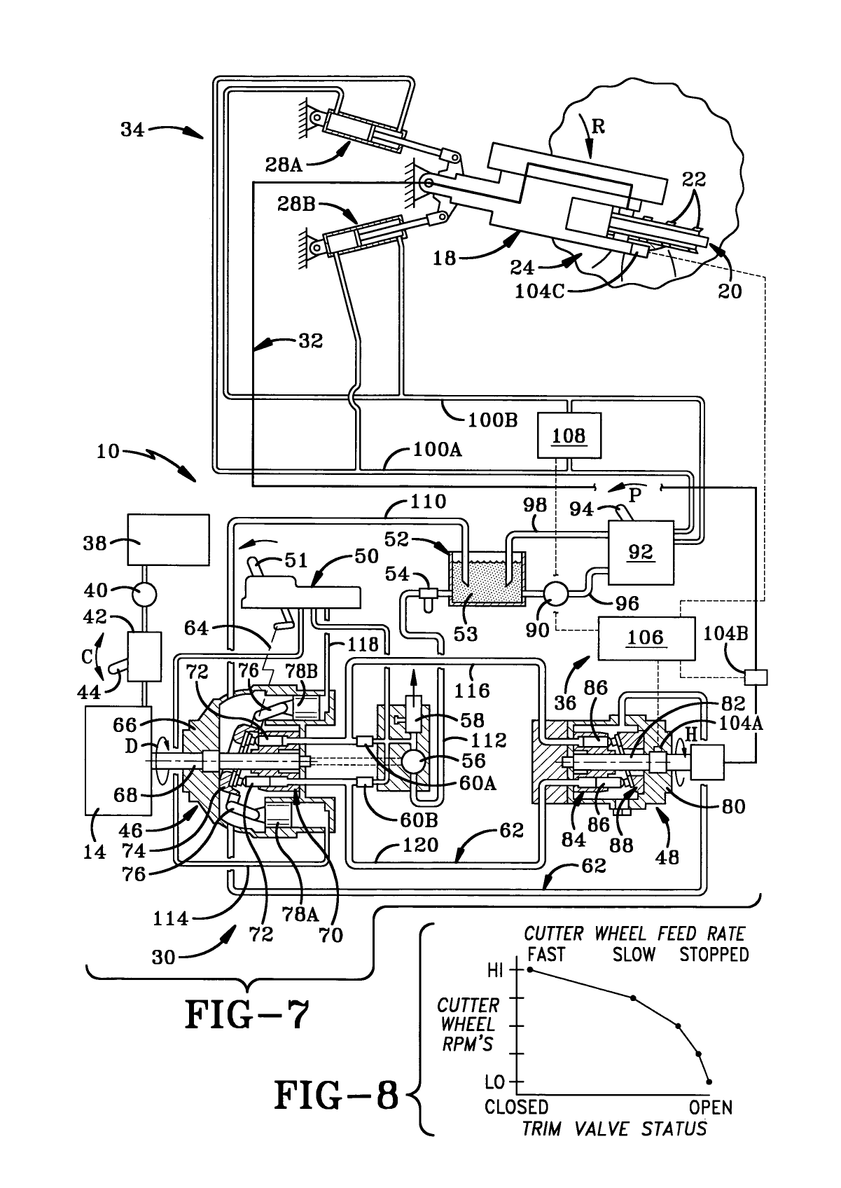

In accordance with a feature of the invention and with continued reference to FIG. 5, automatic load control assembly 36 is then operated to provide such an optimum advance rate of cutter wheel 20 in order to minimize or eliminate impact on the rest of system 10 due to an increased load on cutter wheel 20 and in particular to prevent an overload of engine 14. While it has been stressed that transmission 30 operates in a manner to provide a rotational output thereof which is independent of the rotational speed of engine 14, nonetheless an increased load upon cutter wheel 20 can impact the load experienced by engine 14 as translated back through system 10. However, there is some time delay for this translation to occur. To provide load control, sensor 104 senses various conditions which are directly related to the rotational speed of cutter wheel 20, which is of course varied in response to an increased or a decreased load thereupon during the cutting of stump 24 such that an increased load will tend to slow the speed and a decreased load will tend to increase the speed. When sensor 104 senses an increase or decrease of the rotational speed of cutter wheel 20, it produces a signal which is transmitted to microprocessor 106, which computes a response necessary to counter the load condition on cutter wheel 20 by adjusting the advance rate thereof. More particularly, microprocessor 106 transmits a signal corresponding to this response to trim valve 108 in order to control them accordingly to produce the desired response in the form of a changed advance rate of cutter wheel 20. System 10 is operated in this manner with load control assembly 36 automatically making adjustments to the advance rate of cutter wheel 20 as necessary in order to provide an optimum feed rate and cutting rate of cutter wheel 20 as well as to prevent an overload condition of engine 14 and eliminate or reduce overload on other components of system 10. This operation continues until stump 24 is cut completely, as generally indicated at FIGS. 6 and 7, which respectively indicate further stages of advancement of cutter wheel 20 at Arrows Q and R.

FIG. 8 indicates the nature of the relationship between the cutter wheel speed or RPMs, the cutter wheel feed rate and the trim valve status. More particularly, FIG. 8 indicates the nature of this relationship when the cutter wheel experiences an increased load. Typically, trim valve 108 is closed and cutter wheel 20 is operated at a relatively high RPM. When cutter wheel experiences an increased load, sensor 104 senses this increase and microprocessor 106 controls trim valve 108 to open it to some degree in order to slow the feed rate of cutter wheel 20. Relatively greater loads on cutter wheel 20 translate to a greater reduction in the rotational speed of cutter wheel 20, which is responded to by a relatively greater opening of trim valve 108 to further slow the feed rate of cutter wheel 20. In the most extreme case, when cutter wheel 20 experiences a load that causes it to stop rotating, trim valve 108 is completely opened in order to stop the feed rate of cutter wheel 20.

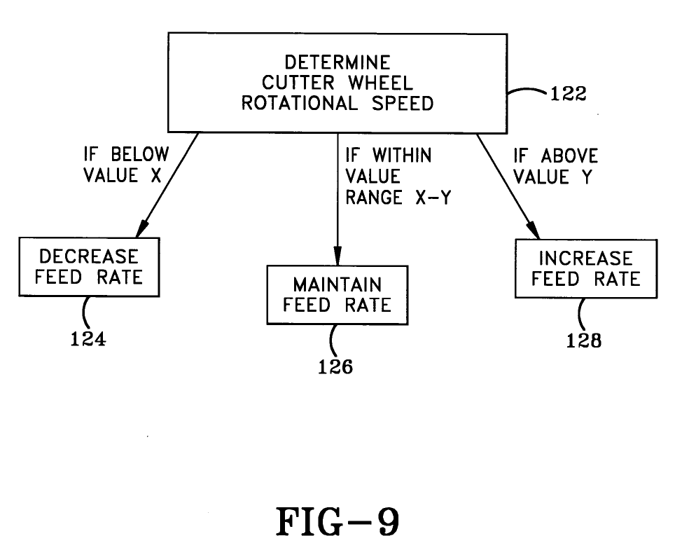

With reference to FIG. 9, system 10 may be configured in order to control the feed rate of cutter wheel 20 with regard to a predetermined rotational speed thereof. More particularly, the rotational speed of cutter wheel 20 is determined as indicated at block 122 in FIG. 9. If the rotational speed of cutter wheel 20 is below a predetermined value X, system 10 will react to decrease the feed rate of cutter wheel 20 as indicated at block 124. If the rotational speed of cutter wheel 20 is within a predetermined value range X through Y, system 10 will operate to maintain the feed rate as indicated at block 126. If the rotational speed of cutter wheel 20 is above a predetermined value Y, system 10 will operate to increase the feed rate as indicated at block 128.

Thus, stump cutter 1 in system 10 provides a stump cutter in which the cutter wheel is advanced via a hydrostatic transmission 30 and the load control assembly 36 is configured to work effectively with such a transmission in order to provide an optimum feed rate and cutting rate of cutter wheel 20 and to reduce or eliminate overload conditions on other components of system 10, especially engine 14. Unlike prior art stump cutters using engines operating at an engine speed which is directly related to the rotational speed of the cutter wheel, stump cutter 1 of system 10 provides for a stump cutter wherein load control assembly 36 is capable of preventing an overload condition of engine 14 during an increased load on cutter wheel 20.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
sensing a load upon a rotating cutter wheel of a stump cutter independently of a rotational speed of an engine which powers the stump cutter; and
controlling the cutter wheel based on the load on the cutter wheel.

2. The method of claim 1 wherein the step of sensing includes the step of sensing a rotational speed of the cutter wheel.

3. The method of claim 2 wherein the step of controlling includes the step of controlling a feed rate of the cutter wheel based on the rotational speed of the cutter wheel.

4. The method of claim 1 wherein the step of sensing includes the step of sensing an increased load on the cutter wheel; and wherein the step of controlling includes the step of controlling the cutter wheel to prevent an increased load on the engine due to the increased load on the cutter wheel.

5. The method of claim 4 wherein the step of sensing includes the step of sensing a reduction of rotational speed of the cutter wheel due to the increased load on the cutter wheel.

6. The method of claim 1 wherein the step of controlling includes the step of controlling the cutter wheel to maintain a rotational speed of the cutter wheel within a desired range.

7. The method of claim 1 wherein the step of controlling includes the step of controlling a feed rate of the cutter wheel.

8. The method of claim 1 further including the steps of producing a signal concerning the load on the cutter wheel; communicating the signal to a microprocessor; computing with the microprocessor a response to the load on the cutter wheel; and signaling a cutter wheel control mechanism to control the cutter wheel.

9. The method of claim 1 further including the steps of operating the engine to provide rotational input to a hydrostatic transmission; and rotating the cutter wheel via the transmission.

10. The method of claim 1 further including the step of controlling a tilt angle of a variable-tilt swash plate to control rotational speed of the cutter wheel.

11. The method of claim 1 further including the steps of:
operating the engine to power a hydraulic motor to produce rotational output at a rotational speed which is independent of the rotational speed of the engine; and
translating the rotational output of the hydraulic motor to rotate the cutter wheel.

12. The method of claim 1 further including the steps of:
operating the engine to power a variable-displacement hydraulic pump; and
controlling a rate of flow of hydraulic fluid with the hydraulic pump to drive a hydraulic motor to produce rotational output to rotate the cutter wheel wherein the rotational output has a rotational speed independent of the rotational speed of the engine.

13. The method of claim 1 further including the steps of:
operating the engine to power a variable-displacement hydraulic pump having a variable-tilt swash plate;
controlling a tilt angle of the variable-tilt swash plate to control reciprocation of a plurality of first pistons;
pumping hydraulic fluid with the first pistons to reciprocate a plurality of second pistons; engaging movably a fixed-tilt swash plate with the second pistons to produce a hydraulically driven rotational output; and
translating the hydraulically driven rotational output to rotate the cutter wheel.

14. A method comprising the steps of:
sensing a load upon a rotating cutter wheel of a stump cutter wherein the cutter wheel is powered by an engine via a hydrostatic transmission; and
controlling the cutter wheel based on the load on the cutter wheel.

15. A stump cutter comprising:
an engine which is operable at an engine rotational speed;
a rotatable cutter wheel having a feed rate;
a sensor for sensing a load on the cutter wheel independently of the engine rotational speed; and
a feed rate control mechanism for controlling the feed rate of the cutter wheel.

16. The stump cutter of claim 15 further including a variable-tilt swash plate for translating rotational input of the engine to rotational output which is independent of the engine rotational input.

17. The stump cutter of claim 15 further including a hydrostatic transmission for translating rotational input of the engine to rotational output which is independent of the engine rotational input.

18. The stump cutter of claim 15 further including a hydraulic pump and hydraulic motor combination for translating rotational input of the engine to rotational output which is independent of the engine rotational input.

19. The stump cutter of claim 15 further including a hydraulic mechanism powered by the engine for translating rotational input of the engine to rotational output which is independent of the engine rotational input.

20. The stump cutter of claim 15 wherein the sensor is a speed sensor for directly or indirectly sensing a speed of the cutter wheel.
